(19) United States
(12) Patent Application Publication
(10) Pub. No.: US 2022/0408008 A1
(43) Pub. Date: Dec. 22, 2022

(54) HIGH-DYNAMIC-RANGE DETECTING SYSTEM

(71) Applicant: Himax Technologies Limited, Tainan City (TW)

(72) Inventors: Yu-Hsuan Chu, Tainan City (TW); Yi-Nung Liu, Tainan City (TW)

(21) Appl. No.: 17/355,026

(22) Filed: Jun. 22, 2021

(51) Int. Cl. H04N 5/235; G06T 5/50; H04N 5/232

(52) U.S. Cl. CPC H04N 5/2355; G06T 5/50; H04N 5/23229; H04N 5/23254; G06T 2207/20208

(57) ABSTRACT

A high-dynamic-range (HDR) detecting system includes a camera module comprising an image sensor; and a vision module that receives data generated by the camera module and accordingly transmits feedback to the camera module. The camera module comprises a multiple-exposure unit that provides different exposure settings, according to which a plurality of images are captured by the image sensor. The vision module comprises an object detection device that detects objects in the plurality of images, thereby resulting in object detection results as metadata.

### BACKGROUND OF THE INVENTION

### 1. Field of the Invention

The present invention generally relates to high dynamic range (HDR), and more particularly to a high-dynamic-range (HDR) detecting system and method.

### 2. Description of Related Art

Dynamic range (DR) is the ratio between the largest value and the smallest value, for example, used in the context of signals such as light.

High Dynamic Range (HDR) is a video and image technology that improves the way light is represented in displays. HDR offers the possibility to represent substantially brighter highlights, darker shadows, more details and more colorful colors, in order to make better use of displays that have high brightness, contrast and colors capabilities.

In conventional HDR detecting systems, camera capture control is commonly based on image intensity distribution, which may be insufficient for user performance due to artificial intelligence (AI) systems may accept different intensity distribution and object details. Moreover, HDR image information of wide dynamic range intensity distribution in real scene may ordinarily incur higher cost in image capture and computation.

A need has thus arisen to propose a novel scheme to overcome drawbacks of the conventional HDR detecting systems.

### SUMMARY OF THE INVENTION

In view of the foregoing, it is an object of the embodiment of the present invention to provide a high-dynamic-range (HDR) detecting system and method performed with reduced cost and computation. In one embodiment, the HDR detecting system and method may provide metadata such as objects with associated locations and objects count for an application.

According to one embodiment, a high-dynamic-range (HDR) detecting system includes a camera module and a vision module. The camera module includes an image sensor. The vision module receives data generated by the camera module and accordingly transmits feedback to the camera module. The camera module comprises a multiple-exposure unit that provides different exposure settings, according to which a plurality of images are captured by the image sensor. The vision module comprises an object detection device that detects objects in the plurality of images, thereby resulting in object detection results as metadata.

### BRIEF DESCRIPTION OF THE DRAWINGS

FIG. 1A shows a block diagram illustrating a high-dynamic-range (HDR) detecting system according to a first embodiment of the present invention;

FIG. 1B shows a flow diagram illustrating an HDR detecting method associated with the HDR detecting system of FIG. 1A;

FIG. 2A shows a block diagram illustrating an HDR detecting system according to a second embodiment of the present invention;

FIG. 2B shows a flow diagram illustrating an HDR detecting method associated with the HDR detecting system of FIG. 2A;

FIG. 3A shows a block diagram illustrating an HDR detecting system according to a third embodiment of the present invention;

FIG. 3B shows a flow diagram illustrating an HDR detecting method associated with the HDR detecting system of FIG. 3A; and

FIG. 3C exemplifies analyzing metadata.

### DETAILED DESCRIPTION OF THE INVENTION

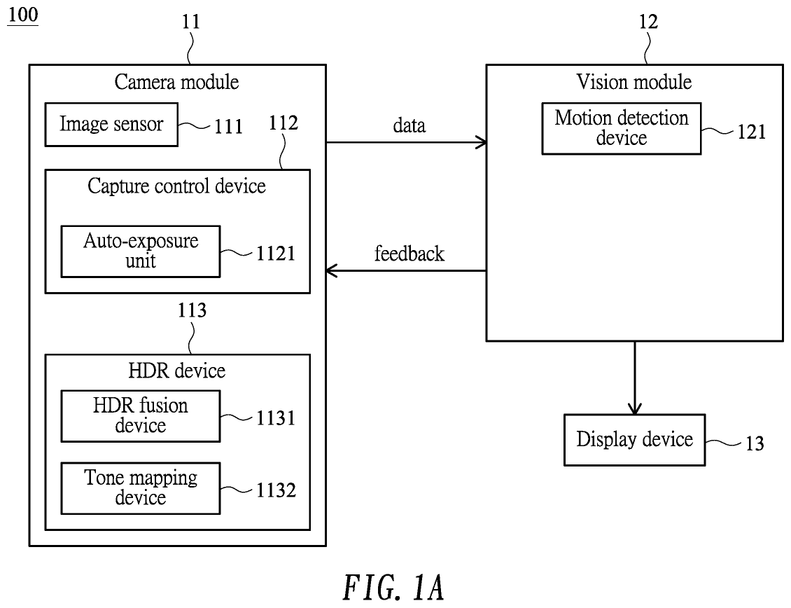

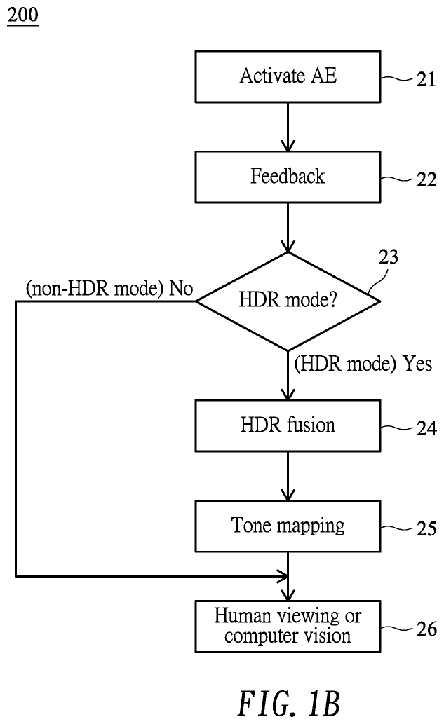

FIG. 1A shows a block diagram illustrating a high-dynamic-range (HDR) detecting system 100 according to a first embodiment of the present invention, and FIG. 1B shows a flow diagram illustrating an HDR detecting method 200 associated with the HDR detecting system 100 of FIG. 1A.

The HDR detecting system 100 of the embodiment may include a camera module 11 and a vision module 12. Specifically, the vision module 12 receives (original) data generated by the camera module 11, and accordingly transmits feedback (information) to the camera module 11. The HDR detecting system 100 of the embodiment may also include a display device 13 operatively coupled to the vision module 12 for human viewing.

In the embodiment, the camera module 11 may include an image sensor 111 configured to capture an image. The camera module 11 may include a capture control device 112, which may include an auto-exposure (or automatic-exposure or AE) unit 1121, such as an exposure meter, configured to automatically calculate and adjust exposure settings for the image sensor 111.

The camera module 11 of the embodiment may include an HDR device 113, such as an image signal processor (ISP), which may include an HDR fusion device 1131 configured to blend multiple images of the same subject captured with different exposure settings (i.e., bracketing) into a single image; and may include a tone mapping device 1132 configured to map one set of colors to another in order to approximate appearance of a high-dynamic-range image.

In the embodiment, the vision module 12, such as an image signal processor (ISP), may include a motion detection device 121 configured to detect a change in a position of an object relative to its surroundings. Generally speaking, the image signal processor of the vision module 12 may perform image signal processing such as distortion correction, sample-rate conversion (e.g., upscaling and downscaling), de-noise filtering, de-blur filtering, gamma correction and contrast limited adaptive histogram equalization.

Referring to the HDR detecting method 200 as illustrated in FIG. 1B, in step 21, the AE unit 1121 is activated and corresponding AE statistics (or parameters) are obtained. In the embodiment, the AE statistics may include intensity range (e.g., minimum, maximum and mean values), global histogram, local histogram, exposure statistics, detection and recognition statistics.

Next, in step 22, a captured image (by the image sensor 111), as the data, is sent to the vision module 12, and is then subject to motion detection by the motion detection device 121, thereby resulting in a motion detection result as the feedback.

In step 23, HDR mode is determined according to the AE statistics and the motion detection result (i.e., the feedback). In the embodiment, HDR mode is decided if one or more of the following criteria have been met: change in the motion detection is less than a predetermined threshold; non-optimized (intensity) distribution after AE converges; single exposure cannot obtain enough texture details for all regions (of the image). On the other hand, non-HDR mode is decided if one or more of the following criteria have been met: change in the motion detection is greater than the predetermined threshold; AE does not converge or scene change happens; single exposure can substantially achieve intensity range of real scene, and obtain enough texture details for all regions; power or frame rate (expressed in frame per second or fps) is limited.

If HDR mode is decided in step 23, multiple images are captured with different exposure settings and blended into a single image by the HDR fusion device 1131 (step 24), followed by performing tone mapping (step 25) by the tone mapping device 1132. It is noted that HDR fusion and tone mapping may be performed by conventional techniques, details of which are thus omitted for brevity. The flow then goes to step 26, in which the image is displayed (by the display device 13) for human viewing or is used for computer vision. If non-HDR mode is decided in step 23, the flow directly goes to step 26.

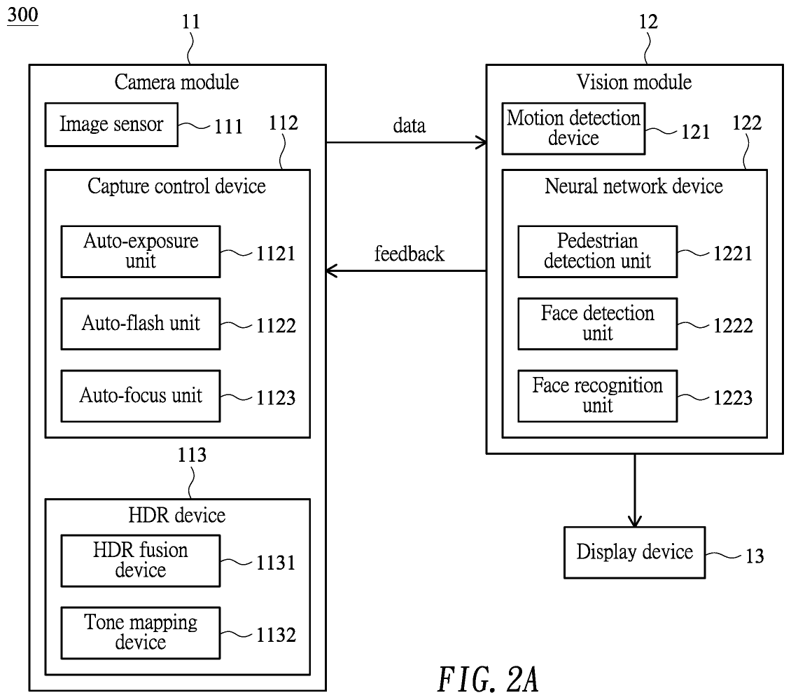

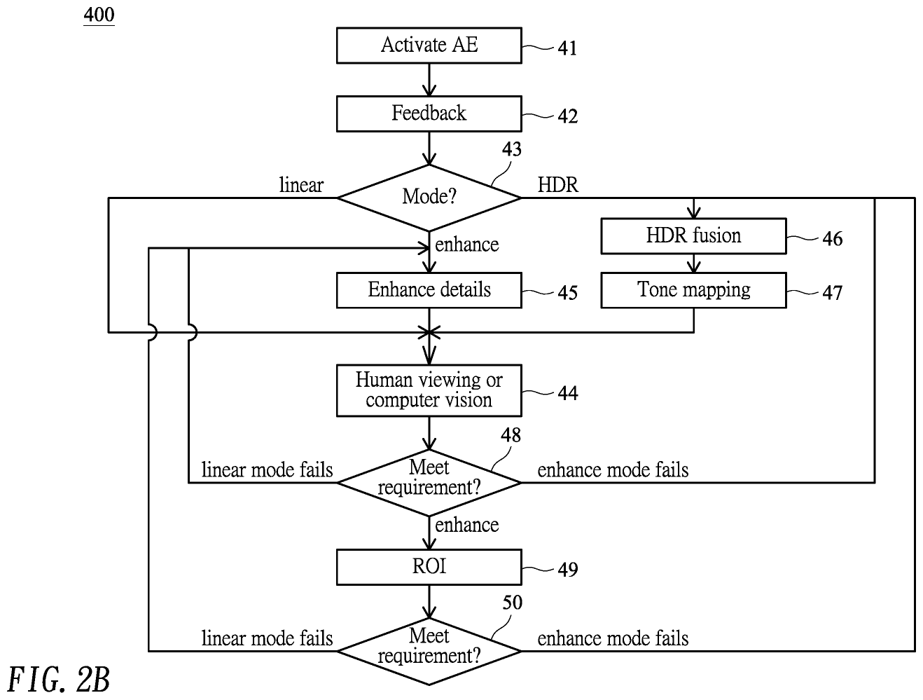

FIG. 2A shows a block diagram illustrating an HDR detecting system 300 according to a second embodiment of the present invention, and FIG. 2B shows a flow diagram illustrating an HDR detecting method 400 associated with the HDR detecting system 300 of FIG. 2A.

The HDR detecting system 300 of the embodiment is similar to the HDR detecting system 100 of FIG. 1A with the following exceptions. Specifically, the capture control device 112 may further include an auto-flash (or automatic-flash) unit 1122 configured to automatically produce a flash of artificial light to help illuminate a scene, for example, according to the feedback provided by the vision module 12. The capture control device 112 may further include an auto-focus (or automatic-focus) unit 1123 configured to automatically focus on a point or area, for example, according to the feedback provided by the vision module 12.

The vision module 12 of the embodiment may further included a neural network device 122 (for computer vision) configured to perform object detection or recognition, such as pedestrian detection by a pedestrian detection unit 1221, face detection by a face detection unit 1222, or face recognition by a face recognition unit 1223. The neural network device 122 may obtain object features, such as locations, sizes and colors, which may be stored in a buffer (not shown).

Referring to the HDR detecting method 400 as illustrated in FIG. 2B, in step 41, the AE unit 1121 is activated and corresponding AE statistics (or parameters) are obtained. Next, in step 42, a captured image (by the image sensor 111), as the data, is sent to the vision module 12, which provides feedback to the camera module 11.

In step 43, a mode is determined according to the AE statistics and the feedback. In the embodiment, one of linear mode, enhance mode and HDR mode (in order of image quality) is determined. Linear mode (adapted to normal light) is decided if single exposure can substantially obtain enough texture details and contrast for all regions (of the image). Enhance mode (adapted to low light or less detail) is decided if a local region has narrow intensity distribution. HDR mode (adapted to wide range illumination environment) is decided if single exposure cannot obtain enough texture details for all regions, or change in the motion detection is less than a predetermined threshold.

If linear mode is decided, the flow goes directly to step 44, in which the image is displayed (by the display device 13) for human viewing or is used for computer vision. If enhance mode is decided, object details such as contrast or edge may be enhanced in step 45, and the flow then goes to step 44. If HDR mode is decided, HDR fusion is performed by the HDR fusion device 1131 in step 46, tone mapping is performed by the tone mapping device 1132 in step 47, and the flow then goes to step 44.

Subsequently, in step 48, it determines whether requirement of image quality is met, for example, by a user or according to detection/recognition result (of the neural network device 122). If the requirement is not met, the mode is switched to next mode with higher image quality. For example, if linear mode fails, the mode is then switched to enhance mode; if enhance mode fails, the mode is then switched to HDR mode.

If the requirement is met, the flow goes to step 49, in which a region of interest (ROI) is determined, for example, according to the motion detection result (from the motion detection device 121) or detection/recognition result (from the neural network device 122).

Next, in step 50, it determines whether requirement of image quality is met, for example, by the user or according to detection/recognition result (of the neural network device 122) in a manner similar to step 48.

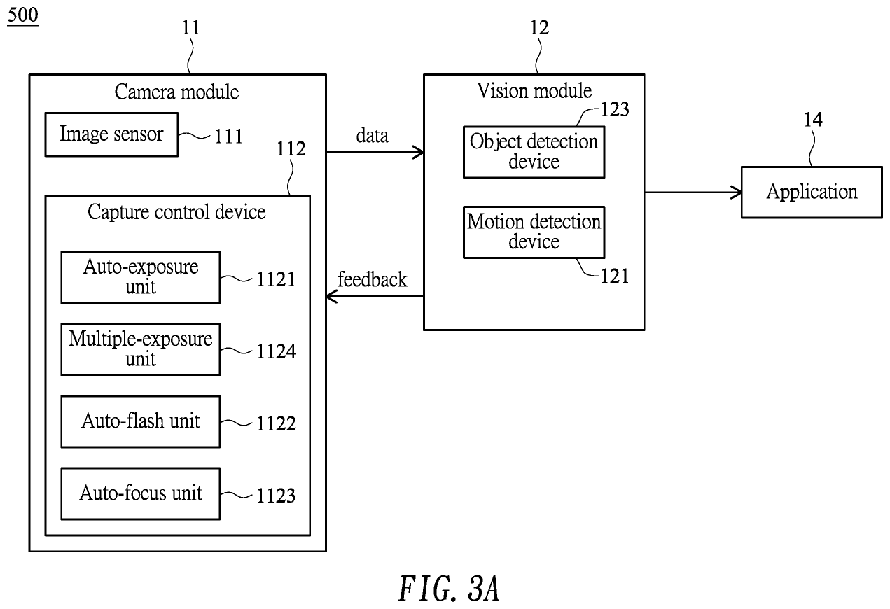

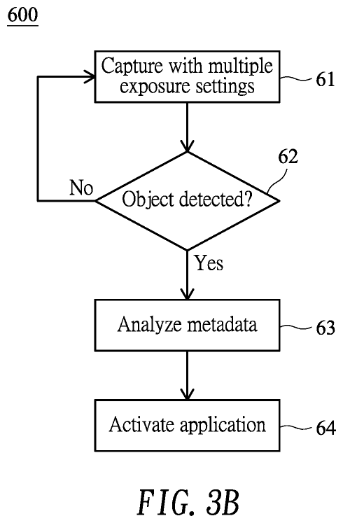

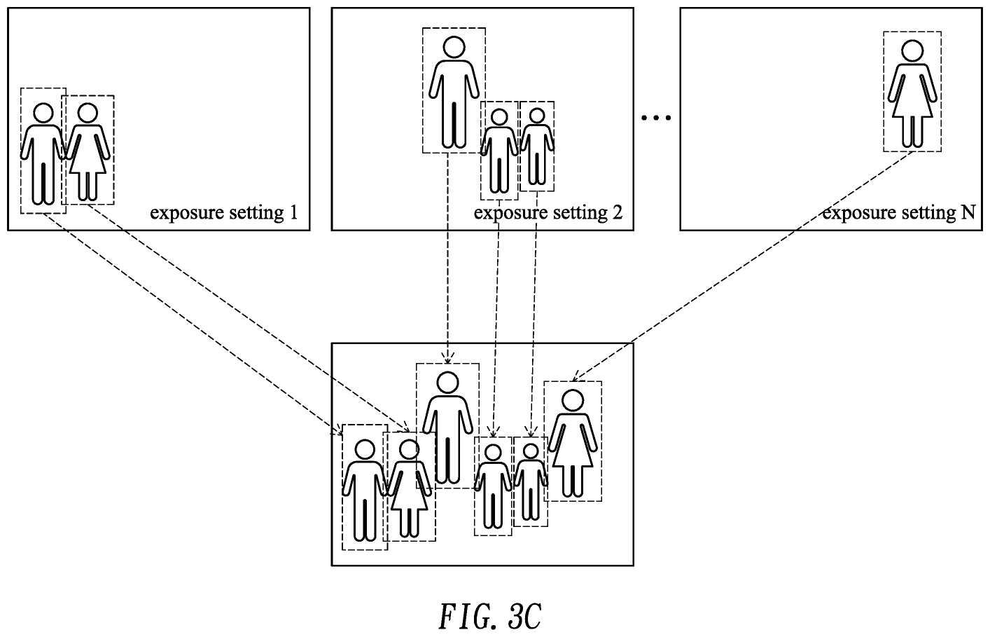

FIG. 3A shows a block diagram illustrating an HDR detecting system 500 according to a third embodiment of the present invention, and FIG. 3B shows a flow diagram illustrating an HDR detecting method 600 associated with the HDR detecting system 500 of FIG. 3A.

The HDR detecting system 500 of the embodiment is similar to the HDR detecting system 100 of FIG. 1A or the HDR detecting system 300 of FIG. 2A with the following exceptions. Specifically, the capture control device 112 may include a multiple-exposure unit 1124 configured to adjust (or provide) different exposure settings, according to which a plurality of images may be captured by the image sensor 111. It is noted that the different exposure settings may benefit different region illumination.

The vision module 12 may further include an object detection device 123 configured to detect objects in the images, thereby resulting in object detection results as metadata. The object detection device 123 may, for example, include a neural network device 122 of FIG. 2A.

Referring to the HDR detecting method 600 as illustrated in FIG. 3B, in step 61, the image sensor 111 captures a plurality of images with different exposure settings (provided by the multiple-exposure unit 1124), respectively. Specifically, the auto-exposure unit 1121 provides a reference exposure setting, and the multiple-exposure unit 1124 accordingly provides multiple exposure settings which are higher and lower than the reference exposure setting.

In step 62, the object detection device 123 detects objects in the images, thereby resulting in object detection results as (plural) metadata. Specifically, the object detection results (or metadata) may include object features, such as locations, sizes and colors.

In one exemplary embodiment, a group of (e.g., three) low-resolution images are first captured with different exposure settings. If an object is detected in step 62, a group of (e.g., three) high-resolution images may be captured with different exposure settings next time, therefore improving recognition rate but with increased power consumption. Alternatively, a group of low-resolution images may be captured next time, therefore maintaining low power consumption.

If no object is detected in step 62, the flow goes back to step 61. Otherwise, the flow goes to step 63, in which the metadata are analyzed (to determine objects count and position distribution, for example). FIG. 3C exemplifies analyzing metadata, in which objects are respectively detected in captured images with different exposure settings. Metadata such as objects with associated locations (and sizes) and objects count are temporarily stored (for example, in a buffer).

In step 64, one or more applications 14 may be activated according to the metadata. In one example, the application 14 is related to system interaction, in which a signal is sent to trigger another equipment with different scene condition and detection result. In another example, the application 14 is related to providing auxiliary suggestion with current scene condition, people or object information. In a further example, the application 14 is related to human postures and tracking, object classification and analysis.

Although specific embodiments have been illustrated and described, it will be appreciated by those skilled in the art that various modifications may be made without departing from the scope of the present invention, which is intended to be limited solely by the appended claims.

What is claimed is:

1. A high-dynamic-range (HDR) detecting system, comprising:
a camera module comprising an image sensor; and
a vision module that receives data generated by the camera module and accordingly transmits feedback to the camera module;
wherein the camera module comprises a multiple-exposure unit that provides different exposure settings, according to which a plurality of images are captured by the image sensor; and
wherein the vision module comprises an object detection device that detects objects in the plurality of images, thereby resulting in object detection results as metadata.

2. The system of claim 1, wherein the camera module comprises:
an auto-exposure unit that automatically calculates and adjusts exposure setting for the image sensor to provide a reference exposure setting; and
a multiple-exposure unit that provides multiple exposure settings according to the reference exposure setting.

3. The system of claim 1, wherein the metadata comprise locations of the detected objects.

4. The system of claim 3, wherein the metadata further comprise count of the detected objects.

5. The system of claim 1, wherein at least one application is activated according to the metadata.

6. The system of claim 1, wherein the object detection device comprises a neural network device.

7. A high-dynamic-range (HDR) detecting system, comprising:
a camera module comprising an image sensor; and
a vision module that receives data generated by the camera module and accordingly transmits feedback to the camera module;
wherein the camera module comprises an auto-exposure unit that automatically calculates and adjusts exposure settings for the image sensor; and
wherein the vision module comprises a motion detection device that detects a change in a position of an object relative to surroundings, thereby resulting in a motion detection result as the feedback.

8. The system of claim 7, further comprising a display device operatively coupled to the vision module for human viewing.

9. The system of claim 7, wherein the camera module further comprises an HDR fusion device that blends multiple images of a same subject captured with different exposure settings into a single image.

10. The system of claim 9, wherein the multiple images are blended if the change is less than a predetermined threshold.

11. The system of claim 9, wherein the camera module further comprises a tone mapping device that maps one set of colors to another in order to approximate appearance of a high-dynamic-range image after the multiple images are blended.

12. The system of claim 7, wherein the vision module further comprises a neural network device that performs object detection or recognition on an image captured by the image sensor.

13. The system of claim 12, wherein the neural network device comprises at least one of the following:
a pedestrian detection unit that performs pedestrian detection;
a face detection unit that performs face detection; and
a face recognition that performs face recognition.

14. The system of claim 7, wherein a mode is determined among a plurality of modes in order of image quality, in which a mode with highest image equality is an HDR mode when the change is less than a predetermined threshold.

15. The system of claim 14, wherein the mode is switched to next mode with higher image quality if requirement of image quality is not met.

16. The system of claim 15, wherein a region of interest (ROI) is determined according to the motion detection result if requirement of image quality is met.

17. The system of claim 7, wherein the camera module further comprises at least one of the following:
an auto-flash unit that automatically produces a flash of artificial light to help illuminate a scene according to the feedback provided by the vision module; and
an auto-focus unit that automatically focuses on a point or area according to the feedback provided by the vision module.
